(19) United States
(12) Patent Application Publication
(10) Pub. No.: US 2009/0050025 A1
(43) Pub. Date: Feb. 26, 2009

(54) Use of Encapsulated Water Soluble Material as a Construction Material

(75) Inventors: Anwar E. Z. WISSA, Orlando, FL (US); Nadim F. FULEIHAN, Orlando, FL (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: TETRA TECH, INC., Pasadena, CA (US)

(21) Appl. No.: 11/842,900

(22) Filed: Aug. 21, 2007

(51) Int. Cl. C04B 28/14; C04B 11/26; E01C 3/00

(52) U.S. Cl. 106/786; 404/31

(57) ABSTRACT

The use of water soluble product in construction that is at least partially encapsulated by a water resistant membrane layer, particularly, the use of phosphogypsum, preferably leached phosphogypsum, that is at least partially encapsulated by a geomembrane layer, thus enabling the use of phosphogypsum as a construction material.

### FIELD

The present disclosure is related to construction, particularly, the use construction of structures that may be exposed to water, such as roads, levees, etc.

### BACKGROUND

Phosphogypsum (with a chemical formula of CaSO₄.2H₂O) is often produced as a by-product of phosphoric acid production at fertilizer plants. Phosphogypsum is generally considered a waste product primarily because contaminated process water is entrained within the gypsum pores (and because there has been some expressed concern about long term exposure to relatively low levels of radioactivity). On the other hand, phosphogypsum that has been leached from contaminants by rainfall infiltration or by washing with fresh water is generally a suitable construction material with excellent frictional characteristics and essentially no adverse health effects except possibly when used in confined or enclosed spaces.

Leached phosphogypsum has already been used in experimental road bases, and the feasibility of its use in road construction in lieu of limestone aggregates is being actively considered (for example, by the State of Florida DOT). Moreover, there has been discussion about the potential use of leached phosphogypsum as fill material for raising flood protection levees (e.g., in Louisiana). Because phosphogypsum is lighter than clay, has a much higher effective angle of internal friction and is much easier to handle, leached phosphogypsum could present significant benefits in raising levees constructed on soft foundation soils.

It is a known fact that phosphogypsum (CaSO₄.2H₂O) is quite soluble in fresh water (about 2 grams per 1000 cc). That solubility raises some concerns when phosphogypsum is used as fill material to raise levees retaining water, or if it is used as construction material in a road base on a pervious foundation because the protective asphaltic or concrete surface course is susceptible to shrinkage cracking over time. The solubility of phosphogypsum results in a loss of material over time, potential piping associated with preferential flow paths, and potential increased sulfate and calcium concentrations in the receiving waters, particularly groundwaters, unless the surface course is regularly maintained and frequently resurfaced. Therefore, a need exists to develop alternative methods to promote beneficial use of the phosphogypsum.

### SUMMARY OF THE DESCRIPTION

These and other aspects of the present disclosure will become more apparent to those skilled in the art from the following non-limiting detailed description of exemplary embodiments taken with reference to the accompanying figures.

The present disclosure relates generally to the use of a water soluble material as a construction material, particularly, the use of phosphogypsum or other similar products as a construction material.

One embodiment relates to encapsulating phosphogypsum used as construction fill in order to control damage to the structure, and deterioration or softening attributed to the solubility of phosphogypsum in flood waters (e.g., in the case of a levee) or due to infiltrating rainfall (e.g., in the case of a road base on a pervious foundation). To achieve this objective, the leached phosphogypsum would be covered or encapsulated by a relatively impervious geomembrane.

In accordance with an exemplary embodiment of the present invention a system and method are provided to use phosphogypsum as a construction material. In accordance with another embodiment of the present invention, a geomembrane is provided to ensure that the phosphogypsum remains relatively free from water.

In accordance with an example of an exemplary embodiment of the present invention, phosphogypsum is used in the construction of a road. The phosphogypsum may be used to create a base or subbase of the road. In addition, the phosphogypsum layer would be covered or encapsulated by a geomembrane. For a road base constructed above the water table, the geomembrane (with or without a geofabric) would cover the upper surface of the gypsum fill and would be placed below the asphaltic or concrete surface course to curtail rainfall infiltration into the gypsum fill.

In accordance with another example of an exemplary embodiment of the present invention, phosphogypsum may be used as a compacted fill material in the construction of a levee. In addition, a geomembrane would be used to separate the gypsum fill material from at least a portion of an external layer which is potentially in contact with water. In another embodiment of the present invention, the geomembrane may separate the fill material from at least a portion of an external layer and the foundation. In yet another embodiment of the present invention, the geomembrane may substantially encapsulate the entire phosphogypsum fill material. For a levee embankment, therefore, a textured geomembrane would be used to cover the upper surface and the upstream face of the gypsum fill and would be anchored in natural ground clays. If the levee foundation is not clayey, the geomembrane would be used to entirely wrap the base, upstream slope, and top surface of the compacted phosphogypsum fill. If erosion protection from overtopping is desired, the entire gypsum fill would be encapsulated by the geomembrane. A thin veneer of grassed clay would be used over the textured geomembrane encapsulating the phosphogypsum.

### BRIEF DESCRIPTION OF THE DRAWINGS

The disclosure is illustrated by way of example and not limitation in the figures of the accompanying drawings in which like references indicate similar elements.

FIG. 1 is a cross sectional view of an example of encapsulated phosphogypsum used in road construction.

FIG. 2 is a cross sectional view of an example of encapsulated phosphogypsum used in road construction.

FIG. 3 is a cross sectional view of an example of encapsulated phosphogypsum used in levee fill.

FIG. 4 is a cross sectional view of an example of encapsulated phosphogypsum used in levee fill.

FIG. 5 is a cross sectional view of an example of encapsulated phosphogypsum used in levee fill.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

According to one embodiment of the present invention, a body of a water soluble material can be used for a variety of purposes, including, but not limited to, roads, levees, etc.

According to exemplary embodiments of the present invention, the water soluble body is constructed using phosphogypsum leached by rainfall or washed with fresh water, designated herein as leached phosphogypsum.

In yet another embodiment of the present invention, the phosphogypsum layer is covered by another separate relatively impervious layer. Preferably, this layer greatly reduces the amount of water that may reach the phosphogypsum layer, since phosphogypsum is soluble in fresh water (with a solubility of approximately 2 grams per 1000 cc). This solubility may raise concerns about the stability of phosphogypsum in certain projects where percolating water may reach the phosphogypsum or where the percolating water through the phosphogypsum may increase sulfate concentrations in the receiving groundwater. More preferably, this outer layer may consist of an impervious geomembrane or liner. It should be noted, however, that any material now known, or hereinafter developed, may be used in the outer layer to reduce that amount of water that reaches the phosphogypsum layer.

An example of a geomembrane in accordance with exemplary embodiments of the present invention is the use of a liner such as that used in landfills. More particularly, a high-density polyethylene plastic liner may be used as the geomembrane. In accordance with aspects of exemplary embodiments of the present invention, the liner may be chemically resistant to corrosion, degradation and damage. In addition, individual sections of the liner may be seamed, joined or welded together, thus ensuring that a continuous seal is created.

Exemplary embodiments of the present invention, in which phosphogypsum is used in roadways and levees, are discussed in greater detail below.

### Use of Encapsulated Phosphogypsum in Road Construction

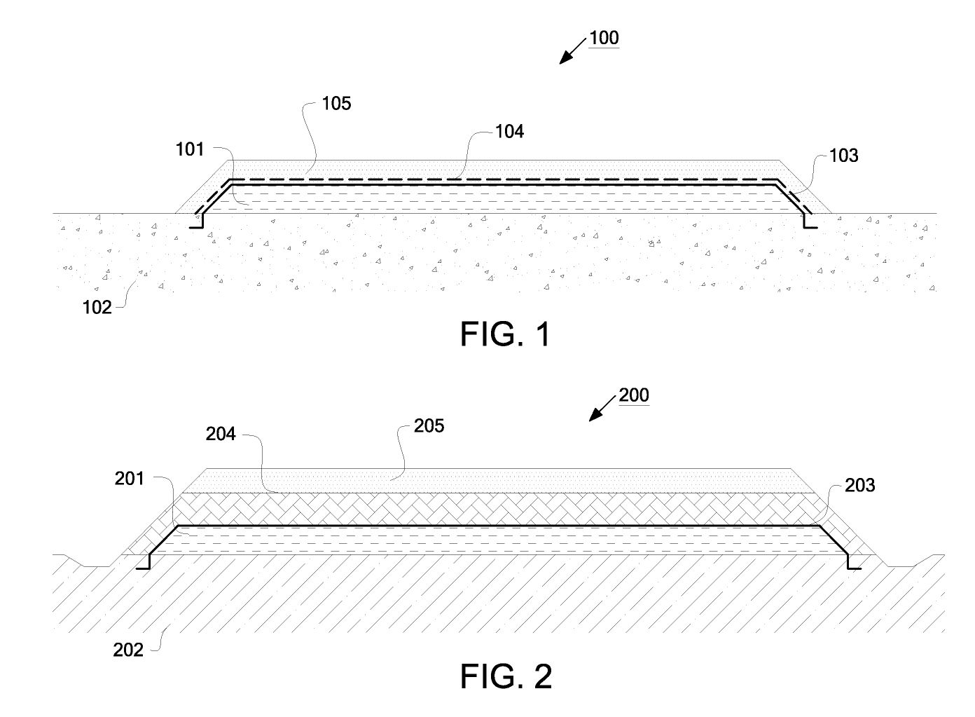

FIGS. 1 and 2 depict examples of exemplary embodiments of the use of phosphogypsum in the construction of roads.

With reference to FIG. 1, an example of an exemplary embodiment of the present invention is depicted. This figure demonstrates the use of encapsulated phosphogypsum in the construction of a road. Particularly, the road system 100 comprises a compacted phosphogypsum base 101. Preferably, in accordance with exemplary aspects of the present invention, the compacted phosphogypsum base 101 comprises leached phosphogypsum.

The phosphogypsum base 101 may lie on top of a compacted subbase 102. The compacted subbase 102 may lie on top of a natural foundation or may be part of an improved natural foundation.

With continued reference to FIG. 1, and in accordance with aspects of the present invention, a geomembrane 103 would be used to cover the phosphogypsum base 101. It is preferable that the geomembrane 103 be impermeable, and allow as little water as possible to reach the phosphogypsum base 101. An example of an exemplary geomembrane in accordance with aspects of the present invention is a liner such as that used in landfills. More particularly, a high-density polyethylene plastic liner may be used as the geomembrane. In accordance with aspects of exemplary embodiments of the present invention, the liner may be chemically resistant to corrosion, degradation and damage. It should be noted, however, that any material now known or hereinafter developed may be used as the geomembrane, such that it assists in preventing water from reaching the phosphogypsum base 101. In accordance with aspects of the present invention, the geomembrane may be positioned so that phosphogypsum base 101 does not come into contact with any layer above the phosphogypsum base, such as, for example, the road surface layer 105. In one embodiment, the geomembrane 103 covers the base 101 to avoid exposing the base to seeping water from above. In exemplary embodiments of the present invention, individual sections of the liner may be joined, seamed or welded together, thus ensuring that a continuous seal is created. The geomembrane 103 may also be anchored into the compacted subbase 102. In one embodiment, the geomembrane 103 is anchored into the compacted subbase 102 through burying the edges into the subbase for improved seal from above and from the side.

In yet another embodiment of the present invention, a protective geofabric layer 104 may be used to cover the phosphogypsum base 101. The woven or non-woven geofabric may comprise synthetic, felt-like fibers such as polyester, polypropylene or nylon fibers. In addition, an optional thin layer of limerock may be added on top of the geofabric to further protect the geomembrane 103 during placement of the surface course 105. Road surface layer 105 lays on top of geomembrane 103, or the geofabric layer and optional thin layer of limerock 104 if present. The road surface layer may comprise any material, either now known or hereinafter developed, that is used for pavement on roads. Examples of such surfaces include concrete, asphalt, and a combination of the two.

FIG. 2 depicts another example of an exemplary embodiment of the present invention. This figure demonstrates the use of encapsulated phosphogypsum in the construction of a road. Particularly, the road system 200 comprises a compacted phosphogypsum subbase 201. Preferably, in accordance with exemplary aspects of the present invention, the compacted phosphogypsum subbase 201 comprises leached phosphogypsum.

The phosphogypsum base 201 may lie on top of a natural foundation 202. The foundation 202 may be prepared for the addition of the phosphogypsum subbase 201. Examples of the preparation of the foundation may include, but is not limited to, leveling, compacting, and excavating.

In accordance with aspects of the present invention, a geomembrane 203 would be used to cover the phosphogypsum subbase 201. It is preferable that the geomembrane 203 be impermeable, and allow as little water as possible to reach the phosphogypsum subbase 201. An example of an exemplary geomembrane in accordance with aspects of the present invention is a liner such as that used in landfills. More particularly, a high-density polyethylene plastic liner may be used as the geomembrane. In accordance with aspects of exemplary embodiments of the present invention, the liner may be chemically resistant to corrosion, degradation and damage. It should be noted, however, that any material now known or hereinafter developed may be used as the geomembrane, as long as it assists in preventing water from reaching the phosphogypsum subbase 201. The geomembrane may be also positioned so that phosphogypsum subbase 201 does not come into contact with other layers above the phosphogypsum subbase, such as, for example, the road surface layer 205. In exemplary embodiments of the present invention, individual sections of the liner may be joined, seamed or welded together, thus ensuring that a continuous seal is created. The geomembrane 203 may also be anchored into the compacted natural foundation 202. The geomembrane 203 covers the subbase 201 from above and is anchored into the natural foundation 202. In one embodiment, the edges of the geomembrane are anchored and buried to a depth similar to that of the ditches at the sides of the road.

In accordance with aspects of an exemplary embodiment of the present invention, a conventional limerock base 204 may lie on top of the geomembrane 203.

Road surface layer 205 may lay on top of limerock base 204. The road surface layer may comprise any material, either now known or hereinafter developed, that is used for pavement on roads. Examples of such surfaces include concrete, asphalt, and a combination of the two. In addition, any method now known, or hereinafter developed, may be used to place the road surface layer 205 onto the road system 200.

### Use of Encapsulated Phosphogypsum in Levee Construction

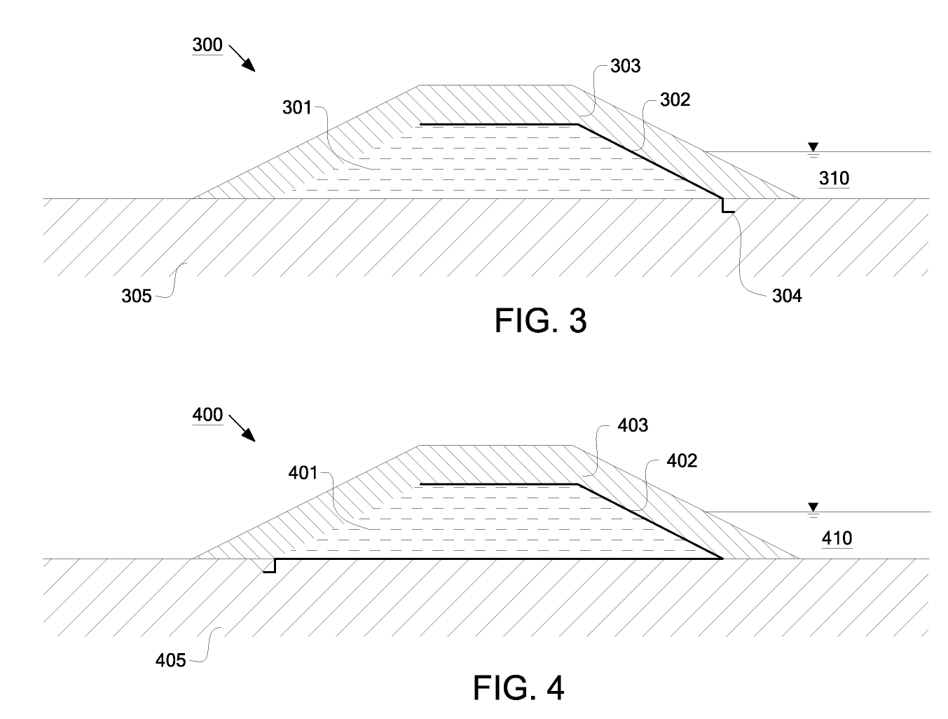

FIGS. 3-5 depict examples of exemplary embodiments of the use of phosphogypsum in the construction or raising of levees. Phosphogypsum is lighter than clay and is much easier to handle than clay. Therefore, there may be significant benefits to using phosphogypsum as opposed to clay or other materials as fill material in levees.

FIG. 3 shows an example of an exemplary embodiment of the present invention. Levee system 300 shows a levee constructed on the banks of a body of water 310. The levee system may have a foundation 305 that is clayey which would limit water penetration. It should be noted, however, that any type of foundation known in the art, or hereinafter known, may be used in the levee system.

Although in one embodiment of the present invention, the foundation 305 comprises a surface that is relatively flat, it should be noted that the foundation 305 does not need to comprise a flat surface and may in fact represent an existing levee which is to be raised.

Compacted phosphogypsum 301, as shown in FIG. 3, may be used to fill the interior of the levee system 300. Preferably, leached phosphogypsum would be used.

With continued reference to FIG. 3, and in accordance with exemplary aspects of the present invention, a geomembrane 302 covers at least a portion of the phosphogypsum 301. Preferably, the geomembrane 302 covers the surface of the phosphogypsum 301 adjacent to the body of water 310. Additionally, the geomembrane 302 may cover the top of the phosphogypsum 301. According to aspects on an exemplary embodiment of the present invention, the geomembrane 302 may comprise a liner such as that used in landfills. More particularly, a textured high-density polyethylene plastic liner may be used as the geomembrane. In accordance with aspects of exemplary embodiments of the present invention, the liner may be chemically resistant to corrosion, degradation and damage. It should be noted, however, that any material now known or hereinafter developed may be used as the geomembrane, as long as it assists in preventing water from reaching the phosphogypsum 301.

In FIG. 3, an edge of the geomembrane is anchored into the clay foundation through burying the edge for a depth. Preferably, the buried depth is sufficient to avoid excessive water from penetrating through the interface with the foundation into the phosphogypsum fill.

In exemplary embodiments of the present invention, individual sections of the liner may be joined, seamed or welded together, thus ensuring that a continuous seal is created. The geomembrane may also comprise a textured geofabric, which may comprise synthetic, felt-like fibers in addition to a geonet of mesh-like plastic.

An external layer 303 covers the outer edge of the levee system 300. The external layer may be comprised of a compacted clay based material.

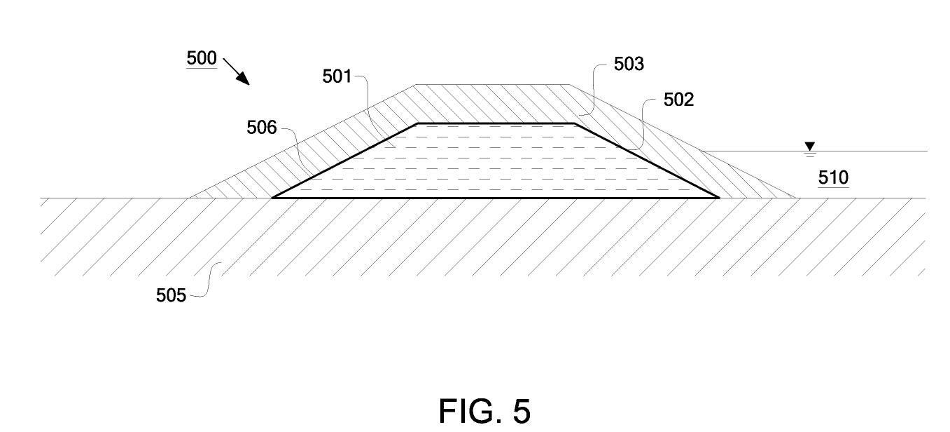

FIG. 4 depicts another example of an exemplary embodiment of the present invention wherein the foundation 405 is not a clay based material and easy for water to penetrate. In this case, it is preferable for the bottom of the phosphogypsum 401 to also be insulated by the geomembrane 402. Therefore, to insulate the phosphogypsum 401 from any water that may seep in through the bottom of the levee through the foundation, the geomembrane 402 is placed between the foundation 405 and the phosphogypsum 401.

According to aspects on an exemplary embodiment of the present invention, the geomembrane 402 may comprise a liner such as that used in landfills. More particularly, a textured high-density polyethylene plastic liner may be used as the geomembrane. In accordance with aspects of exemplary embodiments of the present invention, the liner may be chemically resistant to corrosion, degradation and damage. It should be noted, however, that any material now known or hereinafter developed may be used as the geomembrane, as long as it assists in preventing water from reaching the phosphogypsum 401.

In exemplary embodiments of the present invention, individual sections of the liner may be joined, seamed or welded together, thus ensuring that a continuous seal is created. The geomembrane may also comprise a textured geofabric, which may comprise synthetic, felt-like fibers in addition to a geonet of mesh-like plastic.

The geomembrane 402 does not have to cover the entire bottom of the phosphogypsum fill 401. For example, as long as the combination of the covered bottom portion and the buried depth of the edge prevents water from seeping into the gypsum fill, the edge of the geomembrane 402 away from the body of water 410 may be buried into the foundation 405.

In addition, FIG. 5, depicts and example of an exemplary embodiment of the present invention in which there is not a clay based foundation and the phosphogypsum is also protected against erosion damage caused by overtopping of the levee. In this example, in addition to lining the bottom and water based sides of the levee system 500 (as done in FIGS. 3 and 4), the downstream slope 506 of the phosphogypsum 501 may also be covered by the geomembrane 502. Thus, the phosphogypsum fill 501 is substantially encapsulated in the geomembrane 502.

According to aspects on an exemplary embodiment of the present invention, the geomembrane 502 may comprise a liner such as that used in landfills. More particularly, a textured high-density polyethylene plastic liner may be used as the geomembrane. In accordance with aspects of exemplary embodiments of the present invention, the liner may be chemically resistant to corrosion, degradation and damage. It should be noted, however, that any material now known or hereinafter developed may be used as the geomembrane, as long as it assists in preventing water from reaching the phosphogypsum 501.

In exemplary embodiments of the present invention, individual sections of the liner may be joined, seamed or welded together, thus ensuring that a continuous seal is created. The geomembrane may also comprise a textured geofabric, which may comprise synthetic, felt-like fibers in addition to a geonet of mesh-like plastic.

In the foregoing specification, the invention has been described with reference to specific embodiments. However, it may be appreciated that various modifications and changes can be made without departing from the scope of the present invention as set forth in the claims below. Accordingly, the specification and figures are to be regarded in an illustrative rather than restrictive sense, and all such modifications are intended to be included within the scope of the present invention.

What is claimed is:

1. A system, comprising:
a water soluble body; and
a geomembrane layer to insulate at least a portion of the water soluble body from water.

2. The system of claim 1, wherein the water soluble body is constructed as at least a portion of a road or a levee.

3. The system of claim 1, wherein the water soluble body comprises phosphogypsum that has been leached by rainfall infiltration or washed with fresh water.

4. The system of claim 3, further comprising:
a compacted subbase; and
a road surface layer;
wherein the water soluble body comprises a compacted base created with the phosphogypsum and covered at least in part by the geomembrane layer, the compacted base covers at least a portion of the compacted subbase, and the road surface layer is an external layer of the system.

5. The system of claim 4, further comprising a geofabric placed between the geomembrane layer and the road surface layer.

6. The system of claim 5, further comprising a layer of limerock placed between the geomembrane and the road surface layer.

7. The system of claim 3, further comprising
a foundation; and
a road surface layer;
wherein the water soluble body comprises a subbase created with the phosphogypsum and covered at least in part by the geomembrane layer, the subbase covers at least a portion of the natural foundation, and the road surface layer is an external layer of the system.

8. The system of claim 7, further comprising a limerock base, wherein the limerock base lies between the encapsulated subbase and the road surface layer.

9. The system of claim 3, further comprising:
a foundation; and
an external layer;
wherein the water soluble body of the phosphogypsum lays between the foundation and the external layer, and the geomembrane layer at least partially separates the phosphogypsum from the external layer.

10. The system of claim 9, wherein the geomembrane layer further separates the phosphogypsum from the foundation.

11. The system of claim 10, wherein the geomembrane layer entirely encapsulates the water soluble body of the phosphogypsum.

12. The system of claim 3, further comprising an anchor, wherein the geomembrane layer is anchored into a foundation of the system.

13. The system of claim 3, wherein the geomembrane layer is textured.

14. The system of claim 1, wherein the geomembrane layer includes a liner such as that used in landfills.

15. A method of using a water soluble material in construction of a system, comprising:
providing a geomembrane layer to insulate the water soluble material in the system from water.

16. The method of claim 15, wherein the water soluble material comprises leached phosphogypsum.

17. The method of claim 16, further comprising: constructing a base, subbase or grading fill of a road, wherein the geomembrane layer and an overlying layer encapsulate the phosphogypsum to insulate the phosphogypsum from moisture.

18. The method of claim 16, further comprising: constructing a levee using the phosphogypsum as a fill material, wherein the geomembrane layer is placed between the phosphogypsum and at least a portion of an external layer to insulate the phosphogypsum from moisture.

19. A construction process, comprising:
forming a water soluble body over a foundation; and
placing a geomembrane layer over the water soluble body to insulate at least a portion of the water soluble body from water.

20. The process of claim 19, wherein the water soluble body comprises leached phosphogypsum.

21. The process of claim 20, wherein the phosphogypsum is used in road construction.

22. The process of claim 20, wherein the phosphogypsum is used in levee construction.
